(19) United States
(12) Patent Application Publication
(10) Pub. No.: US 2008/0129594 A1
(43) Pub. Date: Jun. 5, 2008

(54) DUAL-POLARIZATION ANTENNA FEEDS FOR MIMO APPLICATIONS

(76) Inventors: Robert J. Pera, San Jose, CA (US); Thomas J. Birnbaum, Santa Cruz, CA (US)

Correspondence Address: HAHN AND MOODLEY, LLP, P.O. BOX 52050, MINNEAPOLIS, MN, 55402, US

(21) Appl. No.: 11/565,511

(22) Filed: Nov. 30, 2006

(51) Int. Cl. H01Q 5/00; H01Q 21/00; H01Q 9/04

(52) U.S. Cl. 342/361; 343/700 MS

(57) ABSTRACT

Methods and systems for exploiting orthogonal antenna polarizations which restore MIMO capability to an otherwise single path link are disclosed. Disclosed dual-polarization antennae and antennae arrays create two orthogonally polarized independent channels of communication which are transmitted and received by similar dual-polarization antennae, taking advantage of the fact that orthogonally polarized electromagnetic waves travel independently and can be used as independent communication channels. Transmitters and receivers comprising such dual-polarization antennae behave as if two independent communication channels are available in the same line-of-sight link, allowing a doubling of the bandwidth and providing a way to exploit MIMO in outdoor and other line-of-sight communication links.

### FIELD

Embodiments of the invention relate generally to MEMO communications.

### BACKGROUND

Wireless communication networks, such as those based on an IEEE (Institute of Electrical and Electronics Engineers) 802.11 protocol (also known as Wi-Fi), can achieve greater data throughput using a technique known as multiple-input-multiple-output (MIMO). MIMO relies on multiple antennae to exploit multiple electromagnetic transmission paths available to radio signals traveling in a highly reflective indoor propagation environment. However, when deploying MIMO transmitters and receivers in an outdoor environment or any large open area where there is line-of-sight between the transmitter and the receiver, the communication reduces to essentially a point-to-point communication and the underlying multiple transmission paths required by a MIMO communications system are no longer present.

### SUMMARY

Methods and systems for exploiting orthogonal antenna polarizations which restore MIMO capability to an otherwise single path link are provided. In one embodiment, dual-polarization antennae and antennae arrays create two orthogonally polarized independent channels of communication which are transmitted and received by similar dual-polarization antennae, thereby taking advantage of the fact that orthogonally polarized electromagnetic waves travel independently and can be used as independent communication channels. Transmitters and receivers comprising the dual-polarization antennae behave as if two independent communication channels are available in the same to line-of-sight link, allowing a doubling of the bandwidth and providing away to exploit MIMO in outdoor and other line-of-sight communication links.

### BRIEF DESCRIPTION OF DRAWINGS

FIG. 1 illustrates a transceiver system using dual-polarization antenna feeds, in accordance with an embodiment of the present invention.

FIG. 2 illustrates a dual-polarization microstrip patch antenna, in accordance with an embodiment of the present invention.

FIG. 3 illustrates a plurality of dual-polarization patch antenna elements 202 arranged in an array, in accordance with an embodiment of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Multiple-input-multiple-output (MIMO) communication is used in wireless communication networks, such as those based on an IEEE 802.11n protocol. MIMO wireless communications use multiple antennae to exploit the multiple paths available to radio signals traveling in a highly reflective indoor propagation environment. Outdoors, or in large open indoor spaces, there are far fewer reflections and thus less multipath propagation. Therefore MIMO systems rapidly lose their advantage over conventional wireless links in an outdoor environment. When deploying MIMO transmitters and receivers in an outdoor environment or any large open area where there is line-of-sight between the transmitter and the receiver, the communication reduces to essentially a point-to-point communication and the underlying multi-path assumptions of MIMO are no longer valid. In such a scenario, not only does MIMO fail to boost existing line-of-sight bandwidths, but the extra overhead of attempting to exploit MIMO outdoors actually costs throughput or power and MIMO becomes a burden.

The present embodiments disclose techniques which exploit orthogonal polarizations which, especially in outdoor point-to-point links, restore MIMO capability to an otherwise line-of-sight link. As disclosed herein, dual-polarization antennae and antennae arrays create two orthogonally polarized independent channels of communication which are transmitted and received by a similar dual-polarization antenna, taking advantage of the fact that orthogonally polarized electromagnetic waves travel independently and can be used as independent communication channels. A MIMO transmitter or receiver comprising such dual-polarization antennae behaves as if it has two independent communication channels available to it in the same line-of-sight link. This allows a doubling of the bandwidth and provides a way to exploit MIMO in outdoor and other line-of-sight communication links. However, it is understood that the advantages of the present embodiments do not require a line-of-sight link.

While a particularly popular application of MIMO is for communications in accordance with the IEEE 802.11n and similar wireless protocols, it is to be understood that the dual-polarization MIMO techniques disclosed by the present embodiments can in general be applied to communications in accordance with other protocols. Thus, the techniques disclosed herein are not dependent upon any particular frequency range or any particular communication protocol or standard.

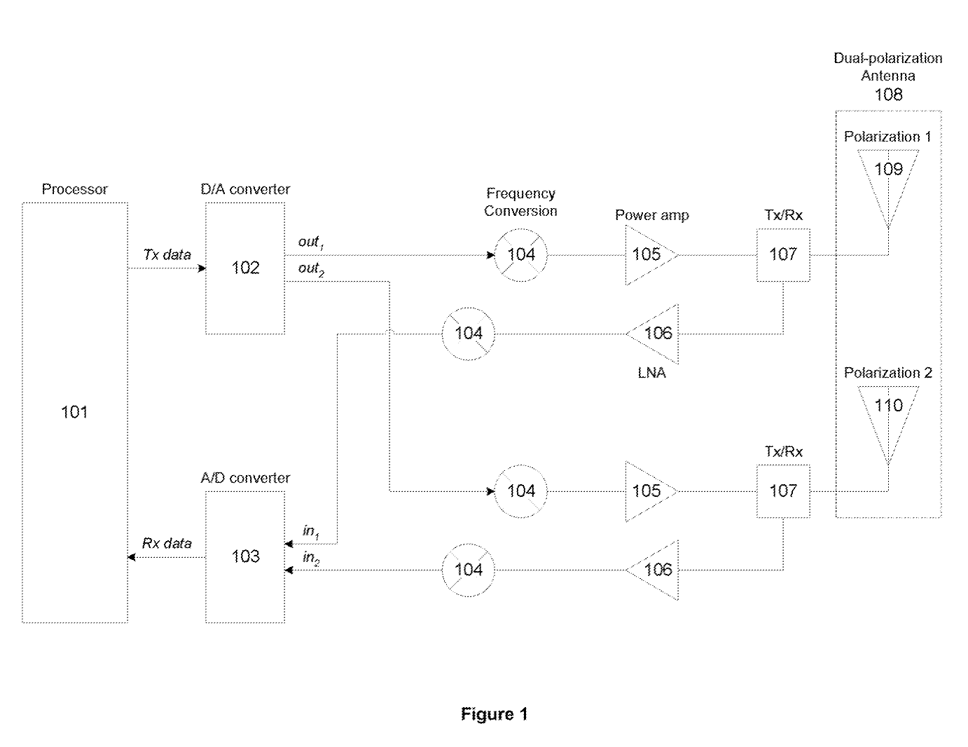

FIG. 1 illustrates a transceiver system using dual-polarization antenna feeds, in accordance with an embodiment of the present invention. The system comprises a processor 101, a digital-to-analog converter 102, an analog-to-digital converter 103, frequency converters 104, power amplifiers 105, low noise amplifiers 106, transceivers 107, and a dual polarization antenna 108 having a first polarization 109 and a second polarization 110.

Processor 101 has access to two independent channels, one per polarization of the dual-polarization antenna 108. To send one signal over the first channel and another signal over the second channel, processor 101 sends the signals to the digital-to-analog converter 102. The signals are converted into two corresponding analog signals (labeled out₁ and out₂), are frequency converted by the converters 104, amplified by the power amplifiers 105, and sent by the transceivers 107 to the dual-polarization antenna 108 for transmission, wherein the first signal out₁ is transmitted according to the first polarization 109 of the antenna 108, and the second signal out₂ is transmitted according to the second polarization 110 of the antenna 108, wherein the polarizations are substantially orthogonal, thereby providing two substantially independent electromagnetic transmissions which can simultaneously and independently carry the two analog signals. The processor 101 may use both channels simultaneously or at different times.

The reception of one signal over the first channel and another signal over the second channel works in a similar manner, as also shown in FIG. 1. Two orthogonally polarized electromagnetic transmissions are received by the dual-polarization antenna 108, with the first transmission carrying the first signal and polarized according to the first polarization 109 of the antenna 108, and the second transmission carrying the second signal and polarized according to the second polarization 110 of antenna 108. The two analog signals (labeled in₁ and in₂) carried by the two transmissions are sent by transceivers 107 to the low noise amplifiers 106, converted by the frequency converters 104 and further converted to digital signals by the analog-to-digital converter 103. The to resulting digital signals represent the received data which are then handled by the processor 101 for downstream processing.

The signals may carry data that is packetized (for example according to an IEEE 80211 or other packet-based communication protocol) or data that is not packetized. In the case of packetized data transmission, the processor 101 prepares the data for transmission as data packets. In the case of packetized data reception, the processor 101 receives the data as packets.

The disclosed techniques can be applied to any type of antenna that can accept two orthogonal inputs to produce two orthogonally polarized electromagnetic fields. By way of example and not limitation, the present techniques are hereinafter disclosed with reference to microstrip patch antennae. Generally, a microstrip patch antenna is etched on a two-layer printed circuit board with a ground plane layer and an antenna element layer. The antenna element is about ½ wavelength in length (representing the resonant length) and typically ¼ to 2 wavelengths wide. It is excited by a feed located at or near one edge. If made square, the antenna will resonate along both the vertical and horizontal axes.

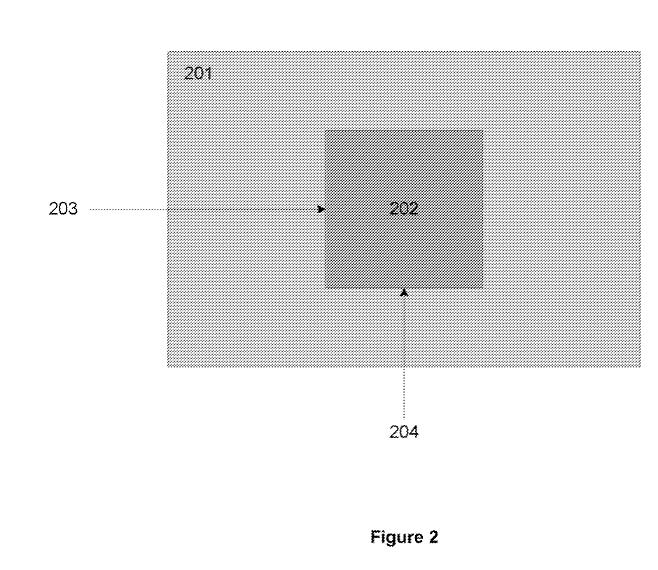

FIG. 2 illustrates a dual-polarization microstrip patch antenna, in accordance with an embodiment of the present invention. The microstrip patch antenna is etched on a two-layer printed circuit board with a ground plane layer 201 and an antenna element layer 202. The antenna is made to be substantially square so that it may resonate along both the vertical and horizontal axes. The square patch antenna is fed in two places orthogonally in order to produce two independent radiated signals. The antenna is excited by a feed 203 located at or near a vertical edge, as well as a feed 204 located at or near a horizontal edge. The two polarizations are generated along the axes of the feeds 203 and 204.

The two feeds interact minimally and for practical purposes can be assumed to be independent channels. When a patch element is excited in one polarization, the fields and the currents on that element are independent and do not interact with the fields and currents flowing in the orthogonal direction. Furthermore, while a portion of the energy going into one polarization feed may leak out of the other polarization feed, it is generally about −20 dB relative to the desired polarization and as a practical matter can be ignored.

Note that a dual-polarization transmitter and receiver can maintain a high communication bandwidth between them as long as their polarizations substantially match, i.e. as long as their relative spatial orientations are such that the vertical and horizontal axes of their antennae are substantially aligned. One way of providing for this relative orientation is to have the receiver and transmitter antennae stationary and in a fixed and aligned orientation relative to each other.

Patch antenna elements can be arranged in many configurations to create antenna arrays for producing higher gain than a single element. Such an array can be used in place of the dual-polarization antenna 108 in the system shown in FIG. 1. As disclosed herein, such antenna arrays can also be fed orthogonally to produce independent channels.

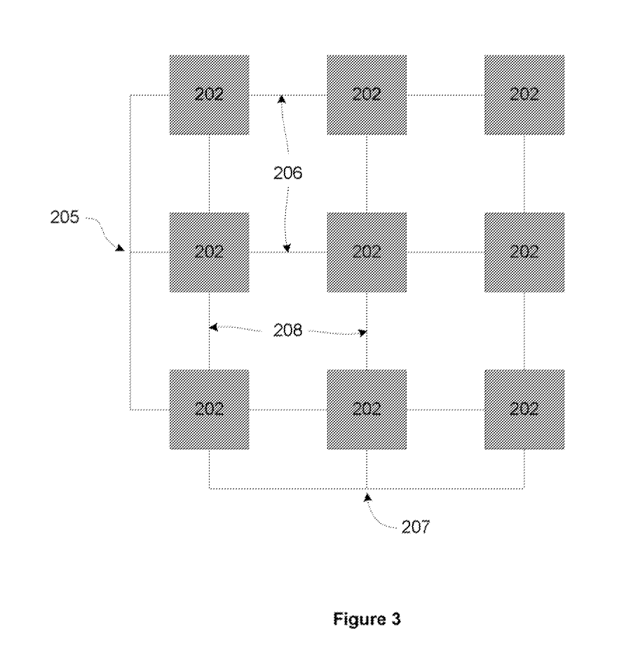

FIG. 3 illustrates a plurality of dual-polarization patch antenna elements 202 arranged in an array, in accordance with an embodiment of the present invention. While the antenna array shown is a 9-element square patch antenna array, the number of elements may vary and can be any other m×n dimensions or other irregular arrangement. The particular antenna array shown in FIG. 3 produces about 8 dB more gain than a single patch antenna element.

In one embodiment, a combination of corporate and series feeding provides an efficient and elegant interconnection scheme providing the antenna elements 202 with feeds of both polarizations. The array is fed by two central energy feed lines 205 and 207, one per polarization. The rows are corporate fed by the central row feed 205 which branches out and is connected to one element 202 per row. Along the rows, the elements 202 are connected in series by row interconnects 206 and are series fed downstream from the corresponding branches of the central row feed 205. The columns are corporate fed analogously by the central column feed 207, with the elements 202 connected in series along the columns by column interconnects 208 and series fed downstream from the corresponding branches of the central column feed 207. As in the case of the single element 202, the two feeds 205 and 207 are independent and represent two independent channels. One advantage of the combination of corporate and series feeding is that complex routing from the feed lines 205 and 206 to individual antenna elements 202 is avoided.

A further advantage of the combining series and corporate feeds, as disclosed herein, is that it helps distribute the energy provided by the central feeds 205 and 207 more evenly across the antenna elements 202. Such even distribution is especially important in high gain antenna applications having an array comprising many antenna elements 202. In one embodiment comprising an n×n array, the central feeds 205 and 207 branch out such that they each split the power evenly across their n branches. The impedance of the antenna elements 202 is designed such that the first antenna element in a series fed sequence of n antenna elements 202 in a row (respectively column) removes only one n-th of the energy from its central row feed 205 branch (respectively column feed 207 branch) and radiates it, allowing the rest of the energy to travel past that antenna element to the remaining elements 202 in the row (respectively column).

The next antenna element in the row (respectively column) removes another one n-th of the supplied energy and radiates it, and so on, until the last element receives the last n-th and radiates it. This way, both feed lines 205 and 207 (for both polarizations) distribute their energy evenly across the elements 202 of the antenna array. The proper impedance of the patch elements 202 for a row (or column) can be determined by using a series of equations which take into account the impedance of the series connected antenna elements in the row (or column), as well as the impedance of their interconnects 206 (or 208), and by iterating until an acceptable approximation is reached, as should be obvious to one of ordinary skill in the art.

The dual-polarization feed technique is not limited to linear polarization, such as the above described vertical and horizontal polarization, but can also be applied using circular polarization. In an alternative embodiment, the individual patch elements are altered to generate circular polarization, with a first polarization being a left hand polarization and a second orthogonal polarization being a right hand polarization. A patch antenna element can be made to generate circular polarization by adjusting its dimension very slightly, for example by feeding it from opposite corners. Since such circular polarizations are also independent, circularly polarized antennae and antenna arrays can be used in place of linearly polarized antennae to produce two independent channels and double the bandwidth.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A system, comprising:
a processor to prepare data for transmission as data packets; and
a transceiver to send some of the data packets over a first communication channel in the form of a first signal having a first polarization, and to send some of the data packets over a second communication channel in the form of a second signal having a second polarization which is orthogonal to the first polarization;
wherein the first and the second channels are in line-of-sight contact with a receiver for receiving the signals.

2. The system of claim 1, wherein the transceiver transmits the first and second signals simultaneously.

3. The system of claim 2, wherein the first and second polarizations are linear.

4. The system of claim 2, wherein the first and second polarizations are circular, with the first polarization according to a left hand sense and the second polarization according to a right hand sense.

5. The system of claim 2, wherein the transceiver comprises one or more antenna elements arranged in an array comprising m rows and n columns.

6. The system of claim 5, wherein the antenna elements are interconnected using a combination of series feeding and corporate feeding.

7. The system of claim 6, further comprising:
a first feed line for supplying energy to the antenna elements according to the first polarization, the first feed line branching out into m branches in a corporate feed to one antenna element per row, the antenna elements connected in series along the rows and series fed downstream from the branches of the first feed line; and
a second feed line for supplying energy to the antenna elements according to the second polarization, the second feed line branching out into n branches in a corporate feed to one antenna element per column, the antenna elements connected in series along the columns and series fed downstream from the branches of the second feed line.

8. The system of claim 7, wherein the impedances of the antenna elements are chosen such that the energy supplied by the first and second feed lines is evenly distributed across the antenna elements

9. The system of claim 2, the transceiver further to receive a third and fourth signal, the third signal according to the first polarization and the fourth signal according to the second polarization.

10. The system of claim 9, wherein the transceiver receives the third and fourth signals simultaneously.

11. A method, comprising:
preparing data for transmission as data packets;
sending some of the data packets over a first communications channel in the form of a first signal having a first polarization; and
sending some of the data packets over a second communications channel in the form of a second signal having a second polarization which is orthogonal to the first polarization;
wherein the first and the second channels are in line-of-sight contact with a receiver for receiving the signals.

12. The method of claim 11, wherein the first and the second signals are transmitted simultaneously.

13. The method of claim 12, wherein the first and second polarizations are linear.

14. The method of claim 12, wherein the first and second polarizations are circular, with the first polarization according to a left hand sense and the second polarization according to a right hand sense.

15. The method of claim 12, wherein the first and second signals are transmitted using antenna elements arranged in an array comprising m rows and n columns.

16. The method of claim 15, wherein the antenna elements are interconnected using a combination of series feeding and corporate feeding.

17. The method of claim 16, wherein a first feed line supplies energy to the antenna elements according to the first polarization, the first feed line branching out into m branches in a corporate feed to one antenna element per row, the antenna elements connected in series along the rows and series fed downstream from the branches of the first feed line, and wherein a second feed line supplies energy to the antenna elements according to the second polarization, the second feed line branching out into n branches in a corporate feed to one antenna element per column, the antenna elements connected in to series along the columns and series fed downstream from the branches of the second feed line.

18. The method of claim 17, wherein the impedances of the antenna elements are chosen such that the energy supplied by the first and second feed lines is evenly distributed across the antenna elements.

19. The method of claim 12, further comprising:
receiving a third and fourth signal, the third signal according to the first polarization and the fourth signal according to the second polarization.

20. The method of claim 19, wherein the third and fourth signals are received simultaneously.
